(19) United States
(12) Patent Application Publication
(10) Pub. No.: US 2021/0300794 A1
(43) Pub. Date: Sep. 30, 2021

(54) ULTRAVIOLET LIGHT FLUID SANITIZATION SYSTEMS

(71) Applicant: Hayward Industries, Inc., Berkeley Heights, NJ (US)

(72) Inventor: Raymond P. Denkewicz, Jr., East Greenwich, RI (US)

(73) Assignee: Hayward Industries, Inc., Berkeley Heights, NJ (US)

(21) Appl. No.: 17/266,526

(22) PCT Filed: Aug. 6, 2019
(86) PCT No.: PCT/US19/45329

§ 371 Date: Feb. 5, 2021

Related U.S. Application Data
(60) Provisional application No. 62/715,090, filed on Aug. 6, 2018.

(51) Int. Cl. C02F 1/32; C02F 1/00; C02F 1/78

(52) U.S. Cl. CPC C02F 1/325; C02F 1/001; C02F 2103/42; C02F 2303/04; C02F 1/78

(57) ABSTRACT

A system for sanitizing and/or disinfecting fluid within a pool or a spa comprising a power supply, at least one ultraviolet light-emitting diode and a processor in communication with the power supply and the at least one ultraviolet light-emitting diode. The at least one ultraviolet light-emitting diode is mounted with respect to the pool or the spa and is in contact with the fluid within the pool or the spa. The processor drives the at least one ultraviolet light emitting diode to emit ultraviolet light at a wavelength to sanitize and/or disinfect the fluid within the pool or the spa.

### RELATED APPLICATIONS

This application claims the benefit of priority to U.S. Provisional Patent Application Ser. No. 62/715,090 filed on Aug. 6, 2018, the entire disclosure of which is hereby expressly incorporated by reference.

### BACKGROUND

### Technical Field

The present disclosure relates generally to the field of fluid sanitization systems. More specifically, the present disclosure relates to fluid sanitization systems utilizing ultraviolet (UV) light generated by at least one light emitting diode (LED) (e.g., a UV LED) and/or ozone to sanitize and/or disinfect fluid (e.g., water) within a pool and/or a spa and the features and/or components thereof.

### Related Art

In the fluid sanitization field, water sanitization assemblies utilizing a conventional UV lamp or bulb are known and commonly used. For example, fluid (e.g., water) sanitization assemblies for sanitizing and/or disinfecting fluid have been developed and are useful in a myriad of applications including, but not limited to, consumer, commercial and industrial applications. However, the lifespan of a conventional UV lamp or bulb is known to degrade over time (e.g., after several thousands of hours of use) and can be difficult to detect other than by recording hours of use or run time. Accordingly, a fluid sanitization system utilizing a conventional UV lamp or bulb can appear functional (e.g., when the lamp or bulb is on) even though the fluid sanitization system is incapable of sanitizing and/or disinfecting the fluid. In addition, the large size of a conventional UV lamp or bulb can limit the placement of the UV lamp or bulb in a fluid sanitization system or preclude its use. Furthermore, a conventional UV lamp or bulb typically consumes a large amount of energy.

As a result of the foregoing, it would be desirable to provide an energy-efficient fluid sanitization systems capable of sanitizing and/or disinfecting water within a pool and/or a spa and the features and/or components thereof over an extended period of time. Accordingly, the UV fluid sanitization systems of the present disclosure address these and other needs.

### SUMMARY

The present disclosure relates to ultraviolet (UV) light fluid sanitization systems utilizing UV light generated by at least one light emitting diode (LED) (e.g., a UV LED) and/or ozone to sanitize and/or disinfect fluid (e.g., water) within a pool and/or a spa and the features and/or components thereof.

The UV light fluid sanitization system 10 includes a power supply, a controller and driver electronics unit, and at least one UV LED mounted with respect to a vessel configured to hold and/or be in contact with fluid. The at least one UV LED emits UV light at a wavelength of approximately 200 nm to 300 nm to sanitize and/or disinfect the fluid. In addition, the UV light fluid sanitization system may further include a venturi mounted with respect to the vessel and configured to introduce oxygen to the fluid within and/or in contact with the vessel. In such a case, the at least one UV LED may also emit light at a wavelength of approximately 185 nm to create ozone to sanitize and/or disinfect the fluid. The UV LED may further include an optic member configured to focus and direct UV light emitted from the UV LED to the fluid within and/or in contact with the vessel to sanitize and/or disinfect the fluid.

### BRIEF DESCRIPTION OF THE DRAWINGS

The foregoing features of the present disclosure will be apparent from the following Detailed Description of the Invention, taken in connection with the accompanying drawings, in which:

FIG. 1A is a block diagram of an ultraviolet (UV) light fluid sanitization system of the present disclosure;

FIG. 1B is a circuit schematic of the UV light fluid sanitization system of the present disclosure;

FIG. 2 is a plan view of a pool and spa UV light fluid sanitization system of the present disclosure;

FIG. 3 is a front view of a pool tile UV light fluid sanitization system of the present disclosure;

FIG. 4 is a perspective view of a deck jet UV light fluid sanitization system of the present disclosure;

FIG. 5 is an exploded view of a spa jet UV light fluid sanitization system of the present disclosure;

FIG. 6 is a side view of a portable UV light fluid sanitization system of the present disclosure;

FIG. 7 is a perspective view of a pool ladder UV light fluid sanitization system of the present disclosure;

FIG. 8 is a side view of a pool cover UV light fluid sanitization system of the present disclosure;

FIG. 9 is a perspective view of a pool skimmer UV light fluid sanitization system of the present disclosure;

FIG. 10A is a side view of a pool cleaner UV light fluid sanitization system of the present disclosure;

FIG. 10B is a cross sectional view of the pool cleaner UV light fluid sanitization system of FIG. 10A; and

FIG. 11 is a cross sectional view of a filter UV light fluid sanitization system of the present disclosure;

FIG. 12A is an exploded view of a pump UV light fluid sanitization system of the present disclosure;

FIG. 12B is a plan view of the pump UV light fluid sanitization system of FIG. 12A of the present disclosure;

FIG. 13 is a front view of an insert UV light fluid sanitization system of the present disclosure;

FIG. 14 is a perspective view of booster pump UV light fluid sanitization system of the present disclosure;

FIG. 15 is a cross sectional view of a multi-position valve UV light fluid sanitization system of the present disclosure;

FIG. 16 is a cross sectional view of a wafer valve UV light fluid sanitization system of the present disclosure;

FIG. 17 is a perspective view of a butterfly valve UV light fluid sanitization system of the present disclosure;

FIG. 18 is a front view of a flow switch controller UV light fluid sanitization system of the present disclosure;

FIG. 19 is a cross sectional view of an ozonator UV light fluid sanitization system of the present disclosure;

FIG. 20 is an exploded view of a cartridge chlorinator UV light fluid sanitization system of the present disclosure;

FIG. 21 is a perspective view of a tablet chlorinator UV light fluid sanitization system of the present disclosure;

FIG. 22 is a side view of a pool heater UV light fluid sanitization system of the present disclosure; and

FIG. 23 is a perspective view of a splash pad UV light fluid sanitization system of the present disclosure.

### DETAILED DESCRIPTION

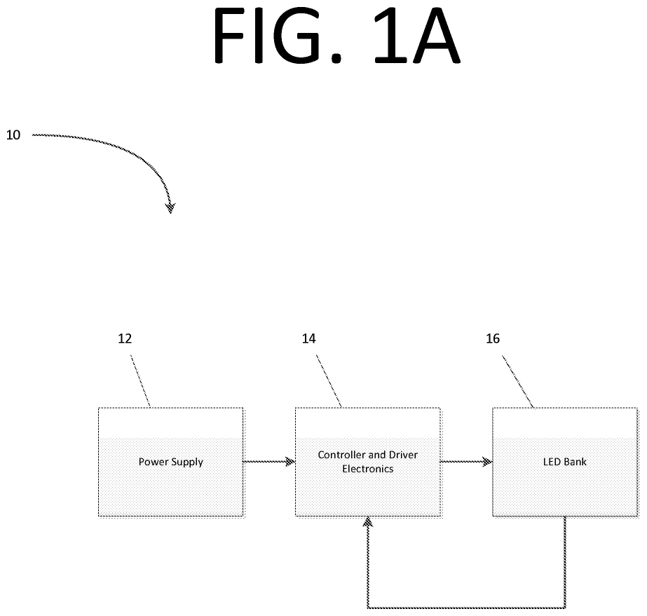

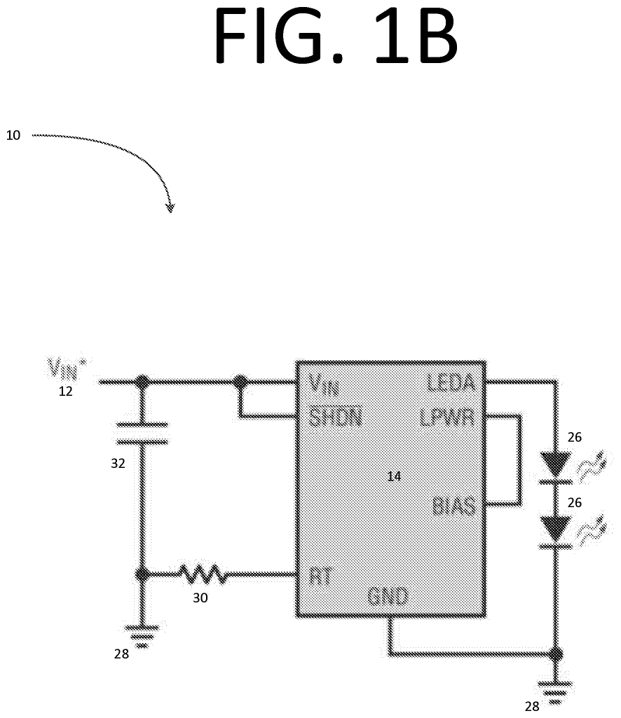

The present disclosure relates to ultraviolet (UV) light fluid sanitization systems utilizing UV light generated by at least one light emitting diode (LED) (e.g., a UV LED) and/or ozone to sanitize and/or disinfect fluid (e.g., water) within a pool and/or a spa and the features and/or components thereof, as described in detail below in connection with FIGS. 1-23.

Turning to the drawings, FIG. 1A is a block diagram of a UV light fluid sanitization system 10 of the present disclosure. The UV light fluid sanitization system 10 includes a power supply 12, a controller and driver electronics unit 14 and at least one UV LED of an LED bank 16. The at least one UV LED of the LED bank 16 may be mounted with respect to a vessel configured to hold and/or be in contact with fluid. The power supply 12 may be a watertight 12 volt direct current (DC) power supply. The controller and driver electronics unit 14 is configured to drive the respective UV LEDs of the LED bank 16.

The at least one UV LED may emit UV light at a wavelength of approximately 200 nm to 300 nm to sanitize and/or disinfect the fluid. The LED bank 16 may also include a plurality of UV LEDs wherein the plurality of UV LEDs may be connected in series or in parallel. A lens of a respective UV LED could be formed using a suitable manufacturing process (e.g., injection molding, compression molding, thermoforming, etc.). The lens could be formed from any suitable, electrically-insulating material, such as glass or a polymeric material (e.g., plastic). Such a material could include, but is not limited to, the amorphous transparent copolymer having a cyclic olefin structure and manufactured by TOPAS Advanced Polymers GmbH under the trade name TOPAS COC. TOPAS COC is a cyclic olefin copolymer copolymerized from norbornene and ethylene using a metallocene catalyst and possesses properties important in optical components such as lenses. For example, TOPAS COC possesses properties including, but not limited to, high transparency, low birefringence, high flowability for precision molding, high heat resistance and negligible water absorption.

An outer surface of the lens may have a silicon dioxide (SiO₂) coating or layer configured to prevent the formation of condensation on an interior portion of the lens. The coating or layer may be deposited by chemical vapor deposition. Alternatively the coating or layer may be formed within the lens or deposited on the interior portion of the lens. The coating or layer insulates the respective UV LED and thereby prevents the formation of condensation caused by a difference between the temperature of the air within the respective UV LED and the temperature of the fluid around the respective UV LED. A respective UV LED may also include an optic member 34 configured to focus and direct UV light emitted from the respective UV LED to the fluid within and/or in contact with the vessel to sanitize and/or disinfect the fluid.

In addition, an optically transparent potting compound could be used to encapsulate the UV LEDs, as well as the printed circuit board (PCB) (not shown) to which the UV LEDs are mounted. The potting compound protects the UV LEDs and the PCB from exposure to water in the event that the UV light fluid sanitization system 10 is no longer watertight, thereby protecting against electrical shock and promoting safety.

The UV light fluid sanitization system 10 may be coupled to a fluid system and/or features and/or components of the fluid system for sanitization purposes. For example, the UV light fluid sanitization system 10 may be coupled to a swimming pool filtration system, a drinking water filtration system and/or a fish tank filtration and aeration system. In addition, the UV light fluid sanitization system 10 may further include a venturi (not shown) mounted with respect to the vessel and configured to introduce oxygen to the fluid within and/or in contact with the vessel. In such a case, the at least one UV LED emits light at a wavelength of approximately 185 nm to create ozone to sanitize and/or disinfect the fluid.

FIG. 1B is a circuit schematic of the UV light fluid sanitization system 10 of the present disclosure. As mentioned above, the UV light fluid sanitization system 10 includes a power supply 12, a controller and driver electronics unit 14 and an LED bank 16 having at least one UV LED 26. In the circuit schematic, power (Vᵢₙ+) is supplied to the input (Vᵢₙ) pin of the controller and driver electronic unit 14 to power the UV LEDs 26 connected in series. The power (Vᵢₙ+) is also coupled to an inverse shutdown (SHDN) pin which powers down the UV light fluid sanitization system 10 in case of an emergency. A resistor 30 is coupled to the oscillator (RT) pin and sets a current from the oscillator (RT) pin. A capacitor 32, coupled to a node shared with the resistor 30, smooths the current from the oscillator (RT) pin. In addition, the circuit schematic is grounded by the ground (GND) pin and the ground 28. It is noted that a plurality of permutations of the circuit schematic may be envisioned.

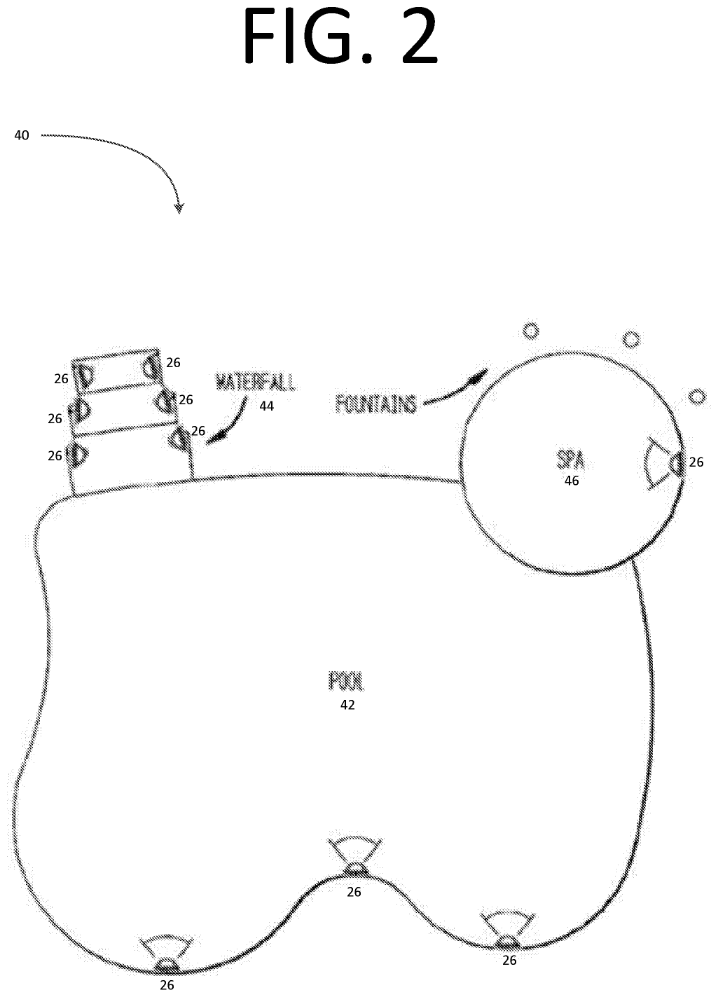

FIG. 2 is a plan view of a pool and spa UV light fluid sanitization system 40 of the present disclosure. As shown in FIG. 2, a plurality of UV LEDs 26 of the UV fluid sanitization system 10 are coupled to respective exterior surfaces of a pool 42, a waterfall feature 44 of the pool 42 and a spa 46. The UV LEDs 26 emit UV light at a wavelength of approximately 200 nm to 300 nm to sanitize and/or disinfect the fluid (e.g., water) in contact with the pool 42, the waterfall feature 44 and the spa 46.

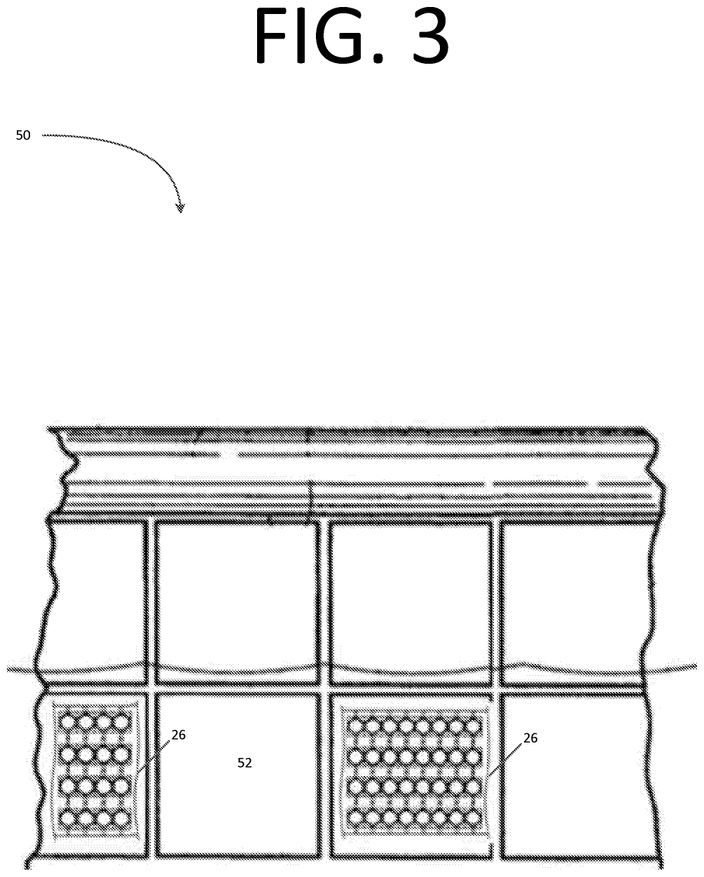

FIG. 3 is a front view of a pool tile UV light fluid sanitization system 50 of the present disclosure. As shown in FIG. 3, respective arrays of UV LEDs 26 are coupled to respective exterior surfaces of pool tiles 52 located beneath a water line of the pool 42 in FIG. 2. The UV LEDs 26 emit UV light at a wavelength of approximately 200 nm to 300 nm to sanitize and/or disinfect the fluid (e.g., water) in contact with the respective exterior surfaces of the pool tiles 52.

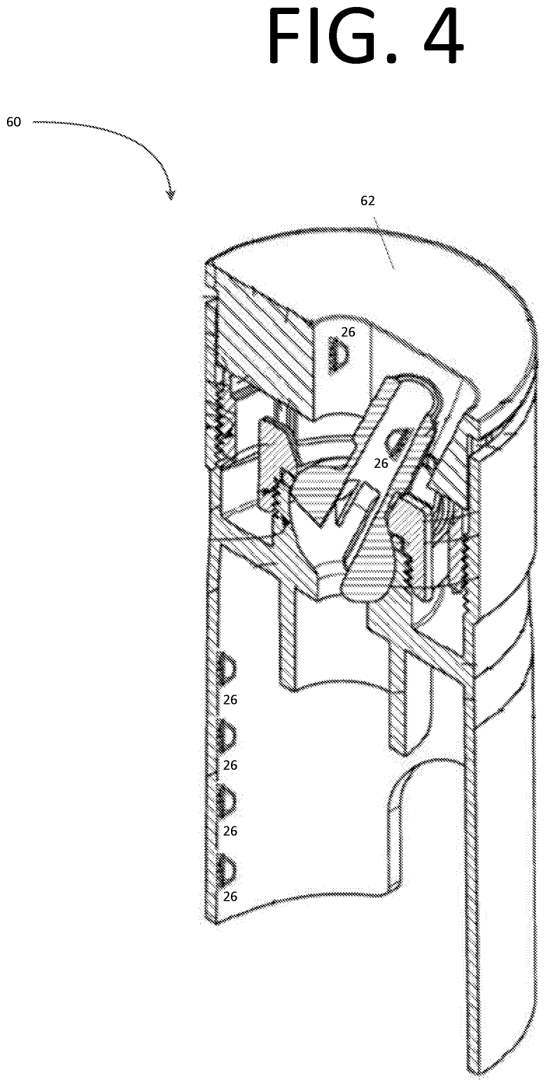

FIG. 4 is a perspective view of a deck jet UV light fluid sanitization system 60 of the present disclosure. As shown in FIG. 4, a plurality of UV LEDs 26 are coupled to interior surfaces of the deck jet 62. The UV LEDs 26 emit UV light at a wavelength of approximately 200 nm to 300 nm to sanitize and/or disinfect the fluid (e.g., water) in contact with the interior surfaces of the deck jet 62.

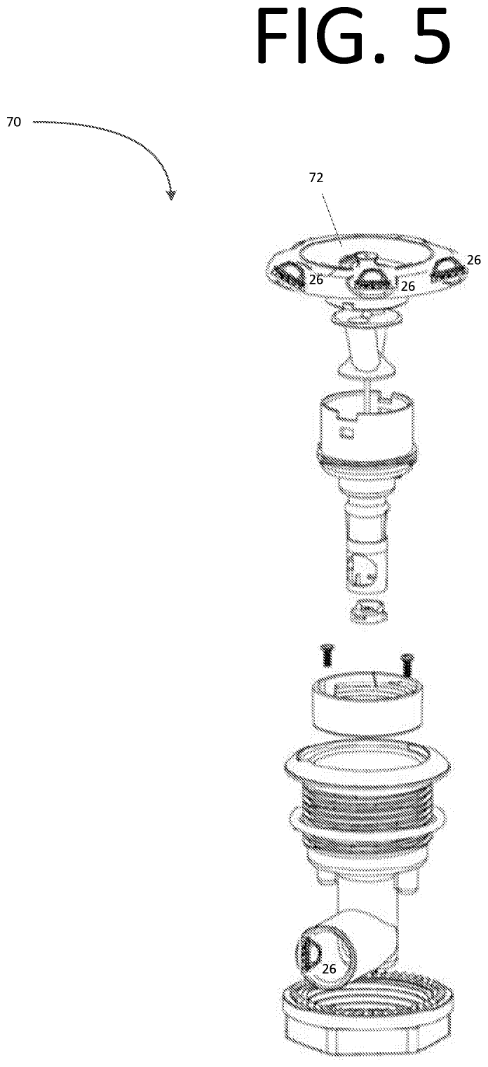

FIG. 5 is an exploded view of a spa jet UV light fluid sanitization system 70 of the present disclosure. As shown in FIG. 5, a plurality of UV LEDs 26 are coupled to interior and exterior surfaces of the spa jet 72. The UV LEDs 26 emit UV light at a wavelength of approximately 200 nm to 300 nm to sanitize and/or disinfect the fluid (e.g., water) in contact with the interior and exterior surfaces of the spa jet 72.

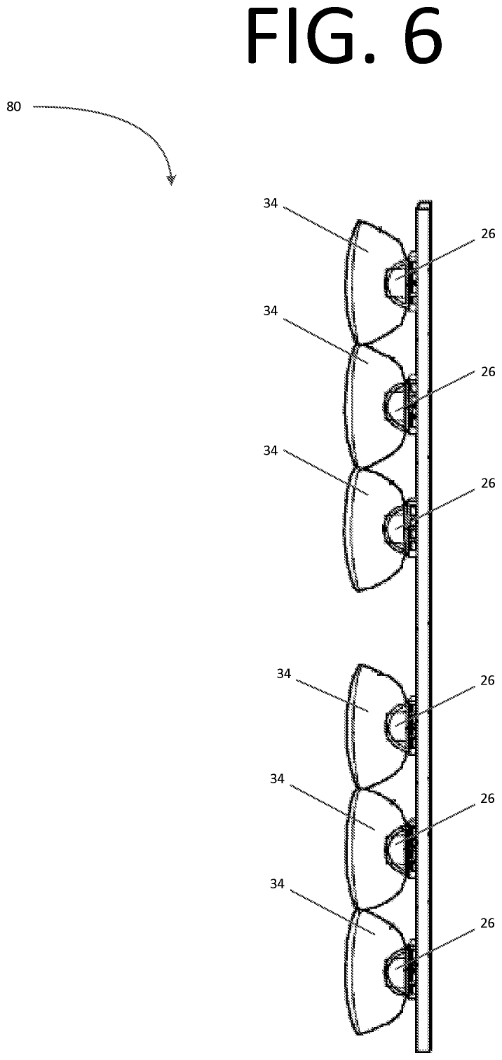

FIG. 6 is a side view of a portable UV light fluid sanitization system 80 of the present disclosure. As shown in FIG. 6, a plurality of UV LEDs 26 are coupled together to form the portable UV light fluid sanitization system 80. The UV LEDs 26 emit UV light at a wavelength of approximately 200 nm to 300 nm to sanitize and/or disinfect the fluid (e.g., water) in contact with the portable UV light fluid sanitization system 80. In addition, the respective UV LEDs 26 have respective optic members 34 configured to focus and direct UV light emitted from the respective UV LEDs 26 to the fluid in contact with the portable UV light fluid sanitization system 80 to sanitize and/or disinfect the fluid.

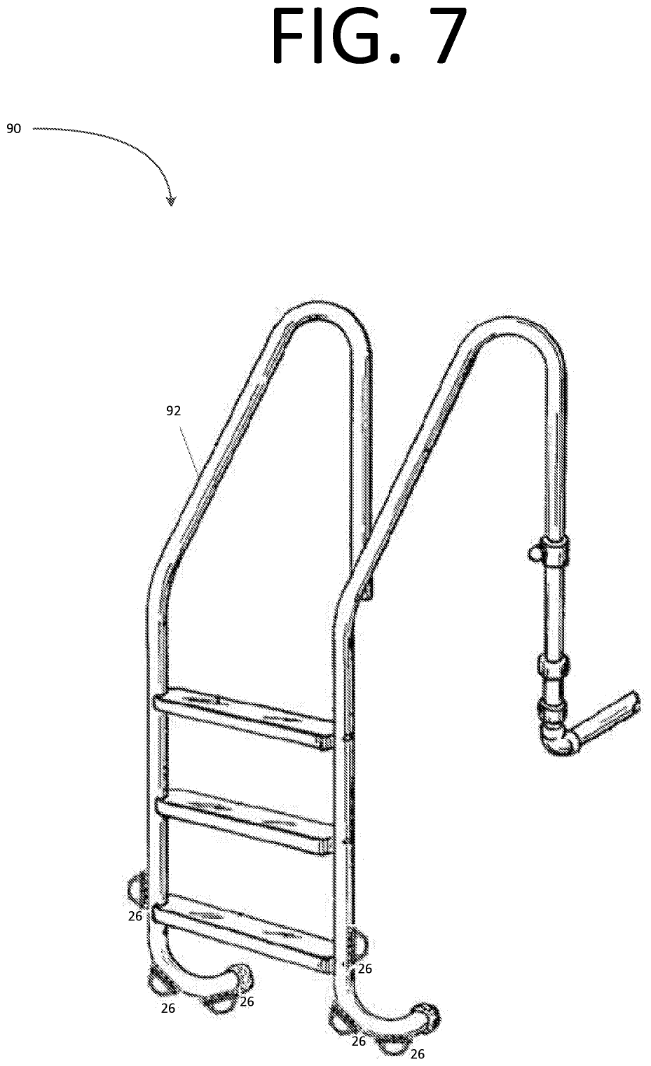

FIG. 7 is a perspective view of a pool ladder UV light fluid sanitization system 90 of the present disclosure. As shown in FIG. 7, a plurality of UV LEDs 26 are coupled to exterior surfaces of the pool ladder 90. The UV LEDs 26 emit UV light at a wavelength of approximately 200 nm to 300 nm to sanitize and/or disinfect the fluid (e.g., water) in contact with the exterior surfaces of the pool ladder 90.

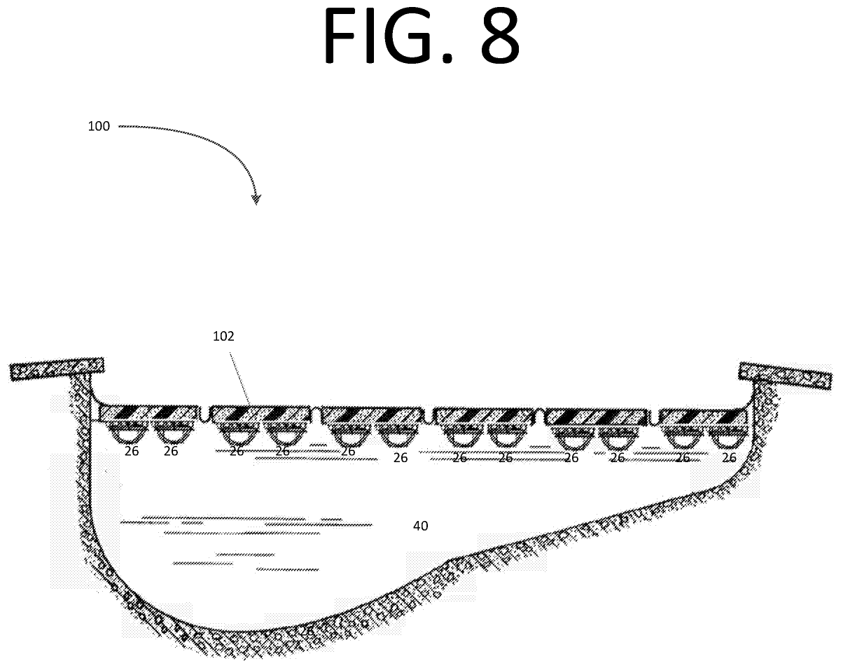

FIG. 8 is a side view of a pool cover UV light fluid sanitization system 100 of the present disclosure. As shown in FIG. 8, a plurality of UV LEDs 26 are coupled to an exterior of the pool cover 102 in contact with the water of the pool 40. The UV LEDs 26 emit UV light at a wavelength of approximately 200 nm to 300 nm to sanitize and/or disinfect the water of the pool 40 in contact with the exterior surfaces of the pool cover 102.

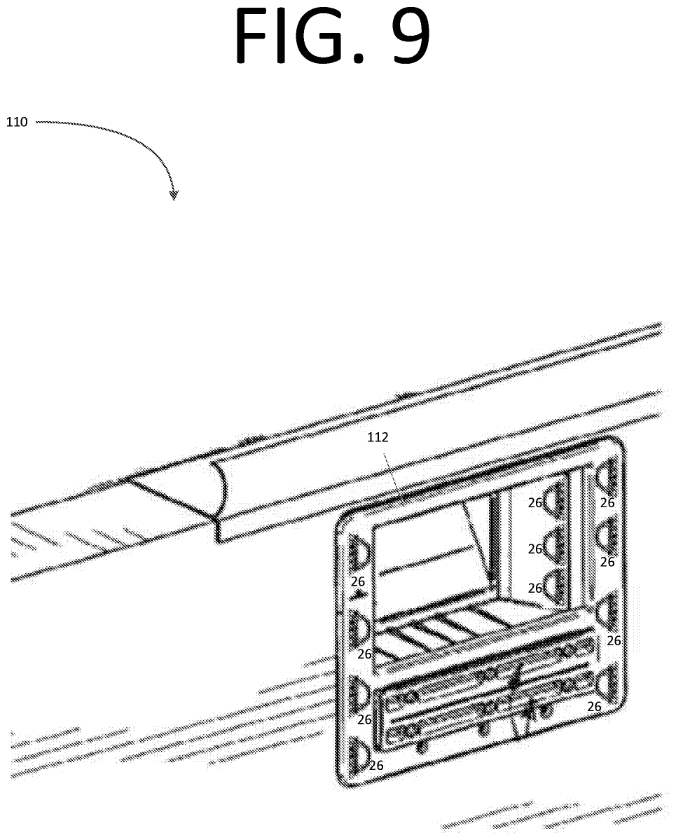

FIG. 9 is a perspective view of a pool skimmer UV light fluid sanitization system 110 of the present disclosure. As shown in FIG. 9, a plurality of UV LEDs 26 are coupled to exterior surfaces of the pool skimmer 40. The UV LEDs 26 emit UV light at a wavelength of approximately 200 nm to 300 nm to sanitize and/or disinfect the fluid (e.g., water) in contact with the exterior surfaces of the pool skimmer 40.

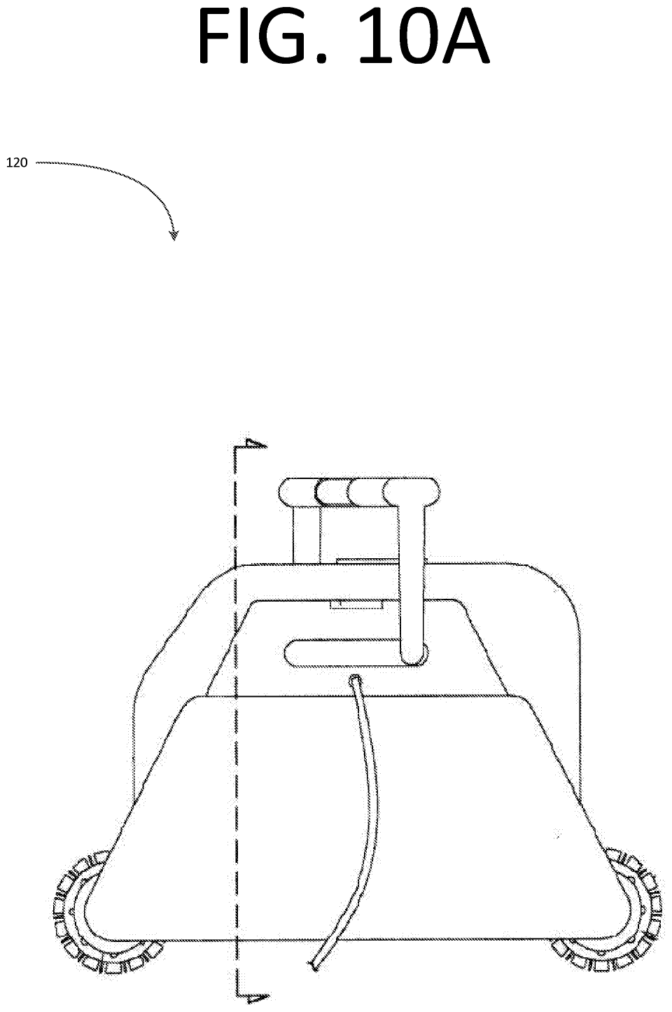

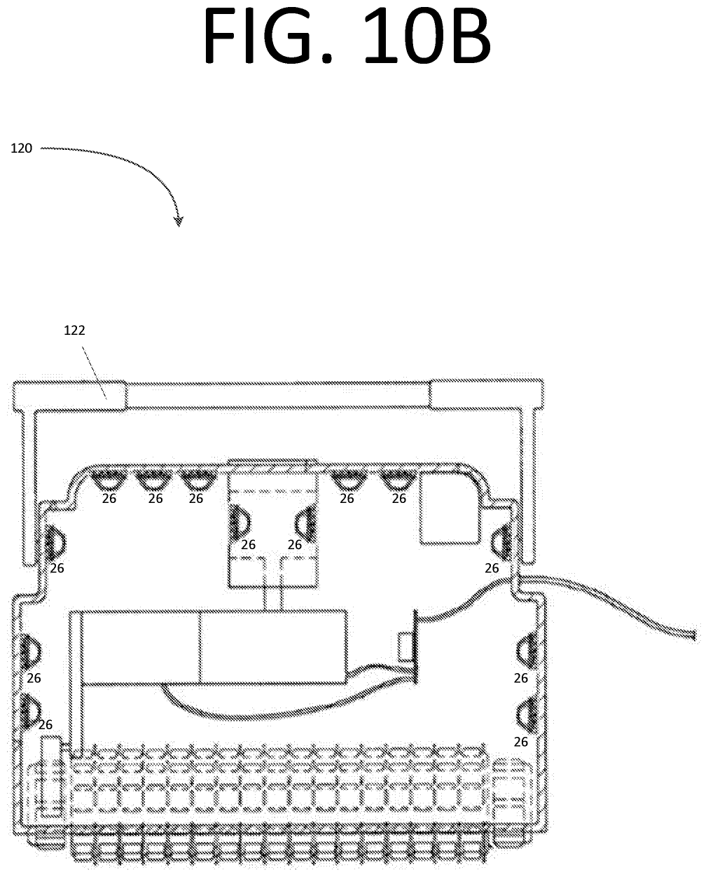

FIG. 10A is a side view of a pool cleaner UV light fluid sanitization system 120 and FIG. 10B is a cross sectional view of the pool cleaner UV light fluid sanitization system 120 of FIG. 10A of the present disclosure. As shown in FIG. 10B, a plurality of UV LEDs 26 are coupled to interior surfaces and components of the pool cleaner 122. The UV LEDs 26 emit UV light at a wavelength of approximately 200 nm to 300 nm to sanitize and/or disinfect the fluid (e.g., water) in contact with the interior surfaces and components of the pool cleaner 122.

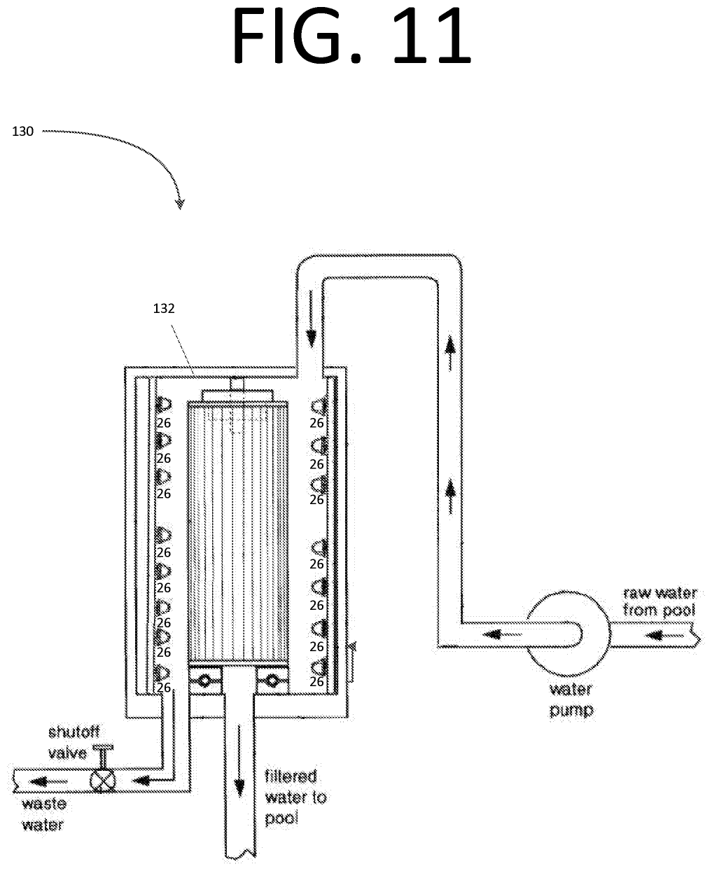

FIG. 11 is a cross sectional view of a filter UV light fluid sanitization system 130 of the present disclosure. As shown in FIG. 11, a plurality of UV LEDs 26 are coupled to interior surfaces of the filter 132. The UV LEDs 26 emit UV light at a wavelength of approximately 200 nm to 300 nm to sanitize and/or disinfect the fluid (e.g., water) in contact with the interior surfaces of the filter 132.

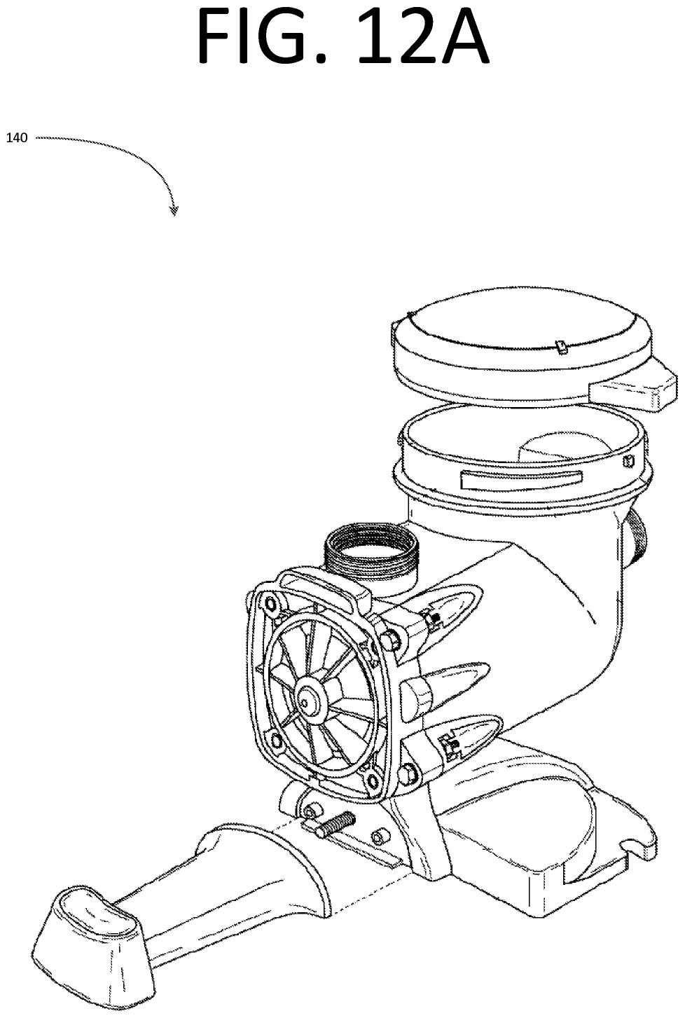

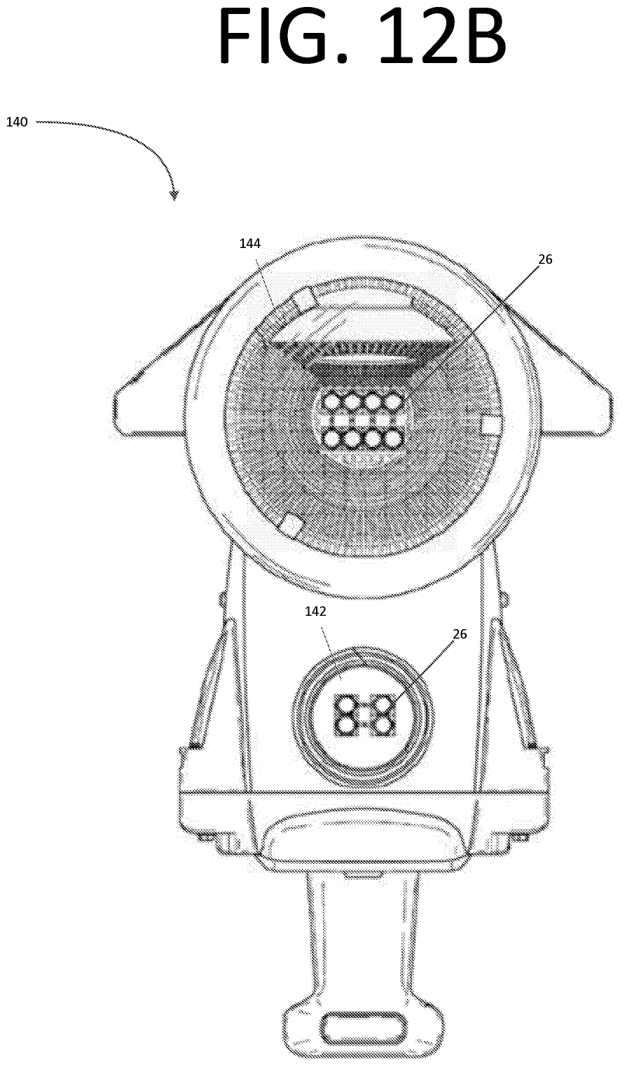

FIG. 12A is an exploded view of a pump UV light fluid sanitization system 140 and FIG. 12B is a plan view of the pump UV light fluid sanitization system 140 of FIG. 12A of the present disclosure. As shown in FIG. 12B, a plurality of UV LEDs 26 are coupled to interior surfaces of the pump 142 and a skimmer basket 144 of the pump 142. The UV LEDs 26 emit UV light at a wavelength of approximately 200 nm to 300 nm to sanitize and/or disinfect the fluid (e.g., water) in contact with the interior surfaces of the pump 142 and the skimmer basket 144 of the pump 142.

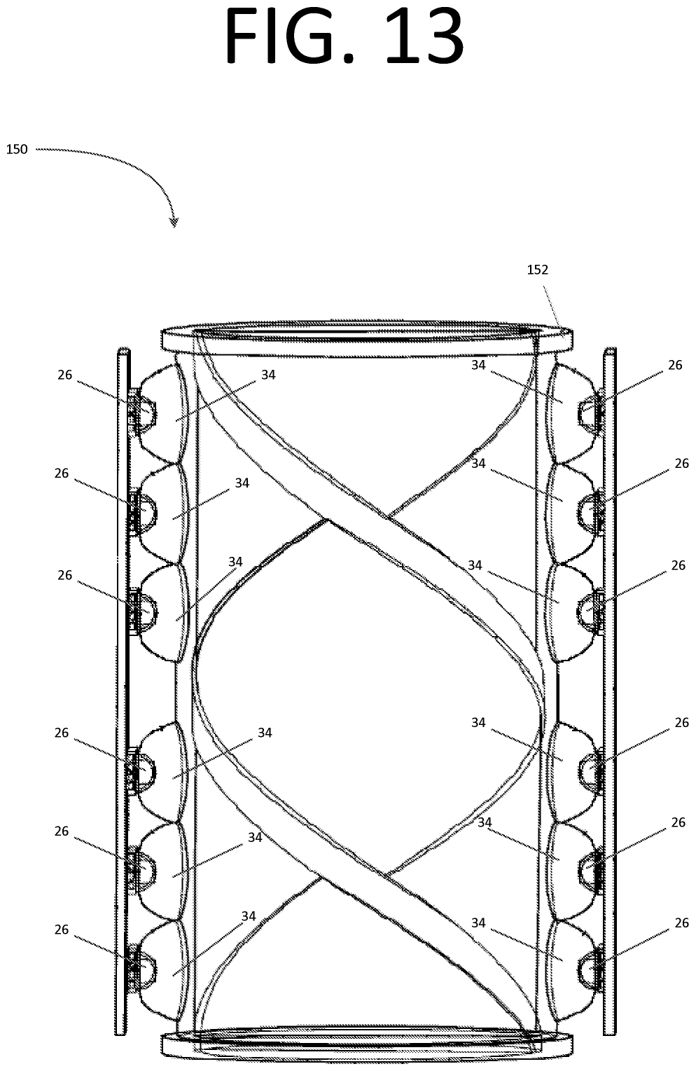

FIG. 13 is a front view of an insert UV light fluid sanitization system 150 of the present disclosure. As shown in FIG. 13, a plurality of UV LEDs 26 are coupled to the insert 152. The insert 152 is configured to be inserted into a component of a fluid system (e.g., a pump). The UV LEDs 26 emit UV light at a wavelength of approximately 200 nm to 300 nm to sanitize and/or disinfect the fluid (e.g., water) in contact with the insert 152. In addition, the respective UV LEDs 26 have respective optic members 34 configured to focus and direct UV light emitted from the respective UV LEDs 26 to the fluid in contact with the insert 152 to sanitize and/or disinfect the fluid.

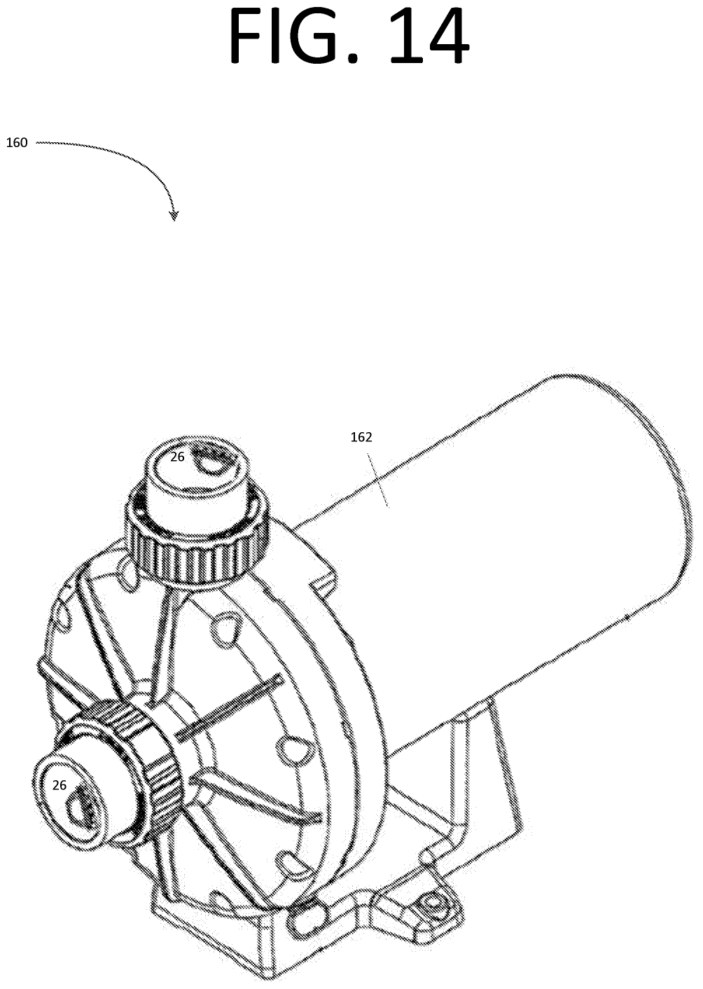

FIG. 14 is a perspective view of booster pump UV light fluid sanitization system 160 of the present disclosure. As shown in FIG. 14, a plurality of UV LEDs 26 are coupled to interior surfaces of the booster pump 162. The UV LEDs 26 emit UV light at a wavelength of approximately 200 nm to 300 nm to sanitize and/or disinfect the fluid (e.g., water) in contact with the interior surfaces of the booster pump 162.

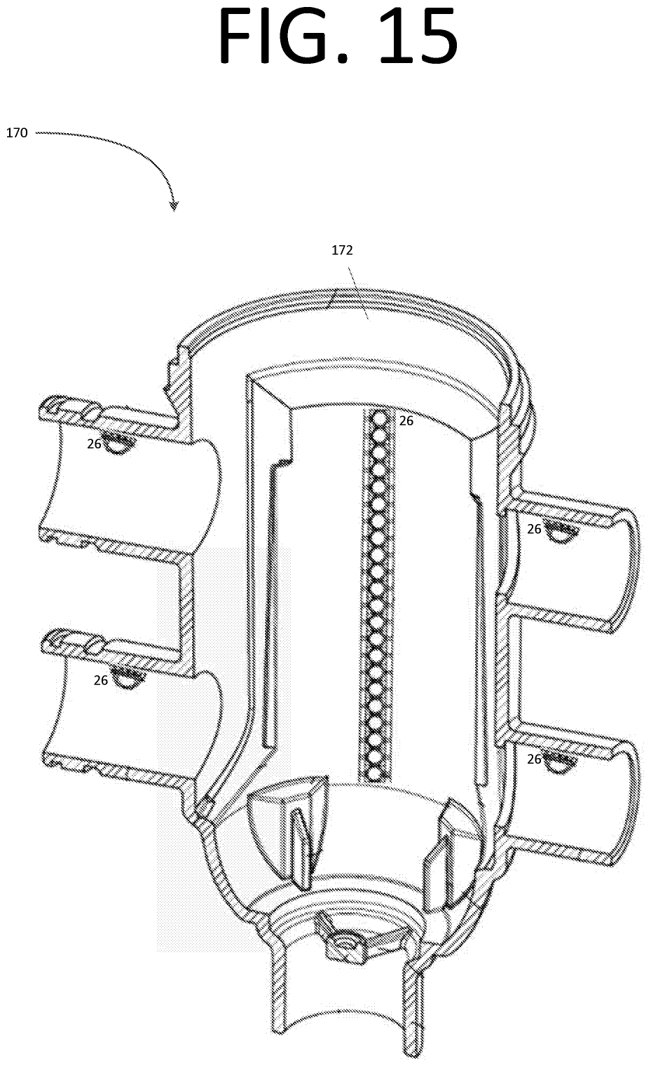

FIG. 15 is a cross sectional view of a multi-position valve UV light fluid sanitization system 170 of the present disclosure. As shown in FIG. 15, a plurality of UV LEDs 26 are coupled to interior surfaces of the multi-position valve 172. The UV LEDs 26 emit UV light at a wavelength of approximately 200 nm to 300 nm to sanitize and/or disinfect the fluid (e.g., water) in contact with the interior surfaces of the multi-position valve 172.

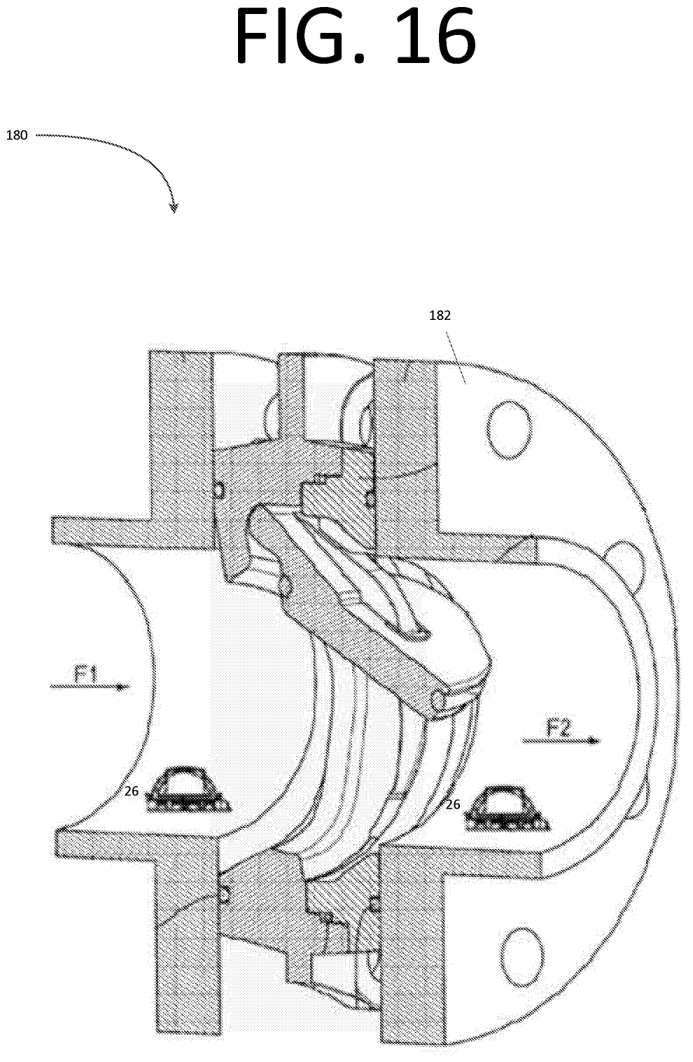

FIG. 16 is a cross sectional view of a wafer valve UV light fluid sanitization system 180 of the present disclosure. As shown in FIG. 16, a plurality of UV LEDs 26 are coupled to interior surfaces of the wafer valve 182. The UV LEDs 26 emit UV light at a wavelength of approximately 200 nm to 300 nm to sanitize and/or disinfect the fluid (e.g., water) in contact with the interior surfaces of the wafer valve 182.

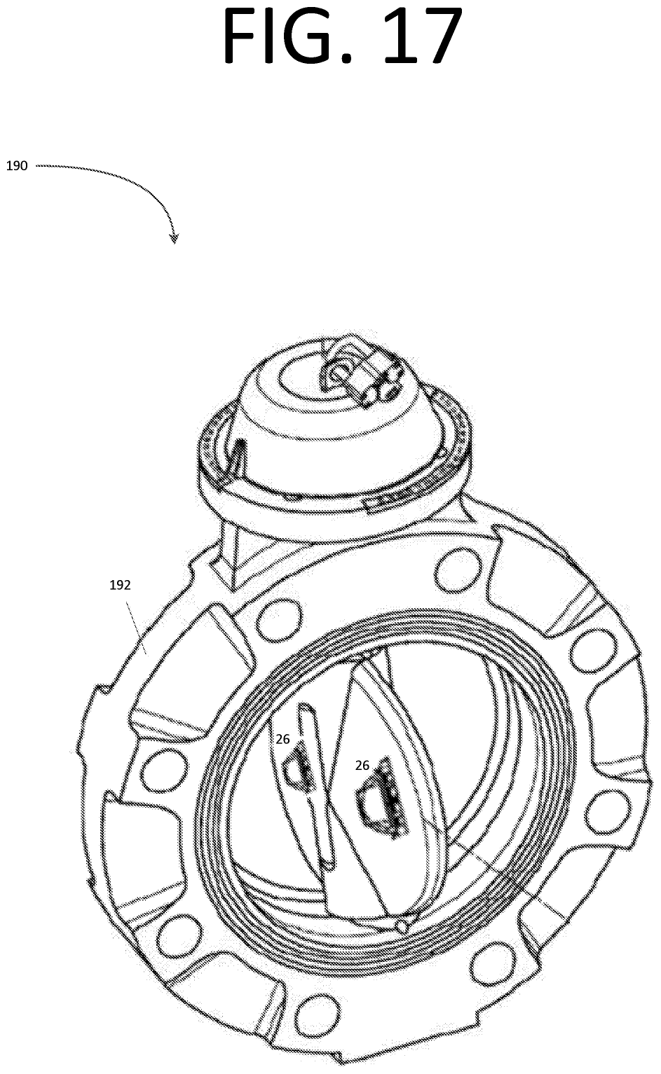

FIG. 17 is a perspective view of a butterfly valve UV light fluid sanitization system 190 of the present disclosure. As shown in FIG. 17, a plurality of UV LEDs 26 are coupled to exterior surfaces of the butterfly valve 192. The UV LEDs 26 emit UV light at a wavelength of approximately 200 nm to 300 nm to sanitize and/or disinfect the fluid (e.g., water) in contact with the interior surfaces of the butterfly valve 192.

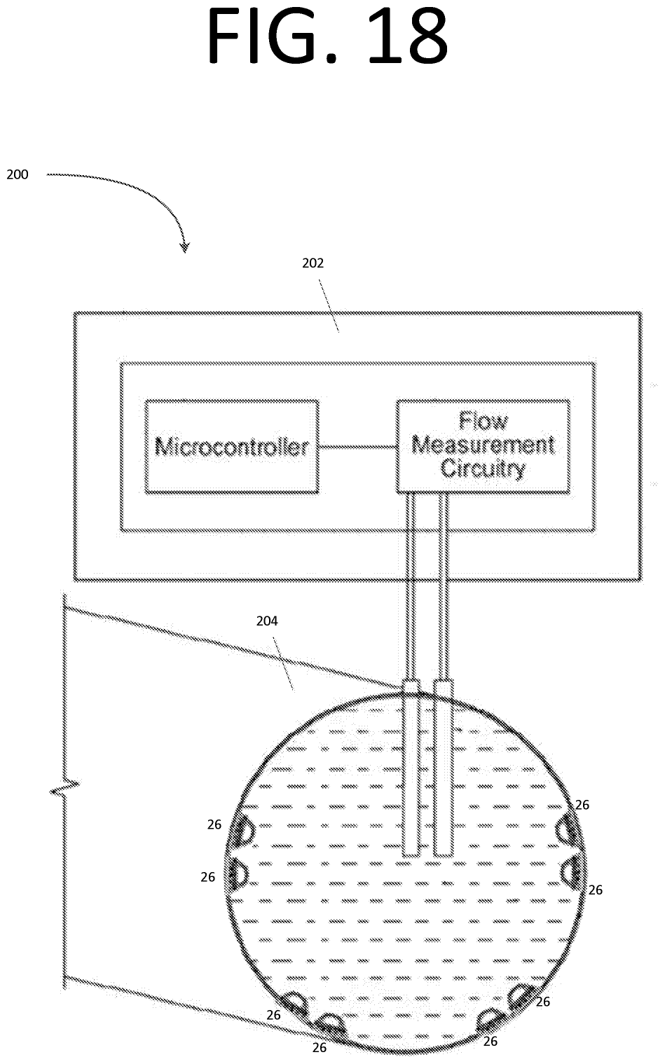

FIG. 18 is a front view of a flow switch controller UV light fluid sanitization system 200 of the present disclosure. As shown in FIG. 18, a plurality of UV LEDs 26 are coupled to interior surfaces of a pipe 204 from which the flow switch controller 202 measures flow. The UV LEDs 26 emit UV light at a wavelength of approximately 200 nm to 300 nm to sanitize and/or disinfect the fluid (e.g., water) in contact with the interior surfaces of the pipe 202.

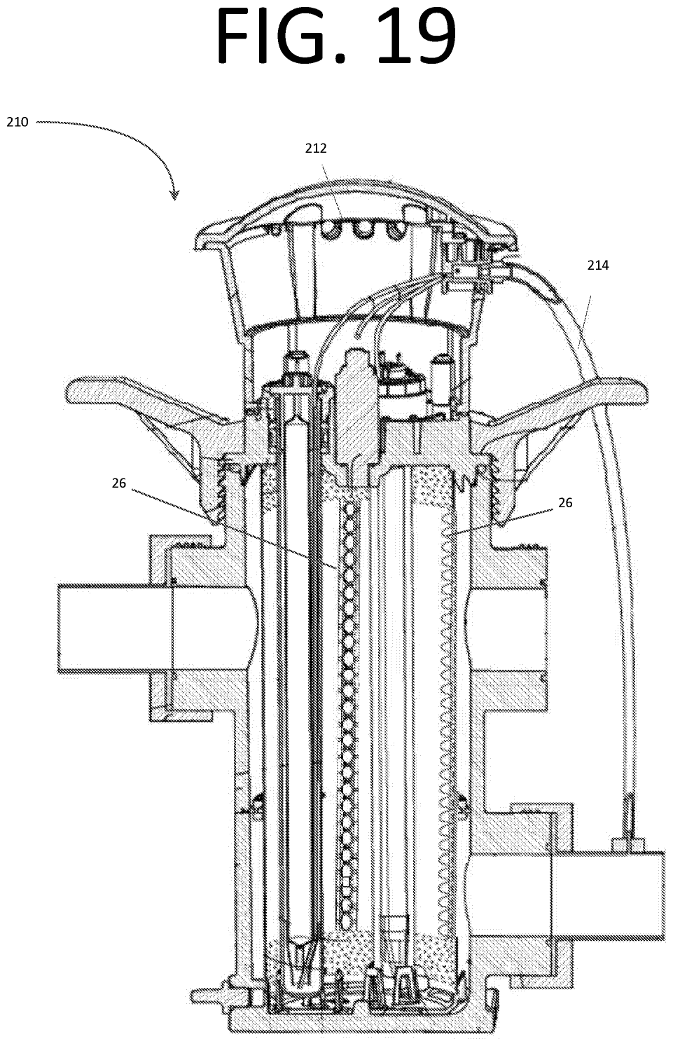

FIG. 19 is a cross sectional view of an ozonator UV light fluid sanitization system 210 of the present disclosure. As shown in FIG. 19, a plurality of UV LEDs 26 are coupled to interior surfaces of the ozonator 212. The UV LEDs 26 emit UV light at a wavelength of approximately 200 nm to 300 nm to sanitize and/or disinfect the fluid (e.g., water) in contact with the interior surfaces of the ozonator 212. In addition, the UV light fluid sanitization system 210 further includes a venturi 214 mounted with respect to the ozonator 212. The venturi 214 is configured to introduce oxygen to the fluid within and/or in contact with the ozonator 212. Further, the UV LEDs 26 emit light at a wavelength of approximately 185 nm to create ozone to sanitize and/or disinfect the fluid.

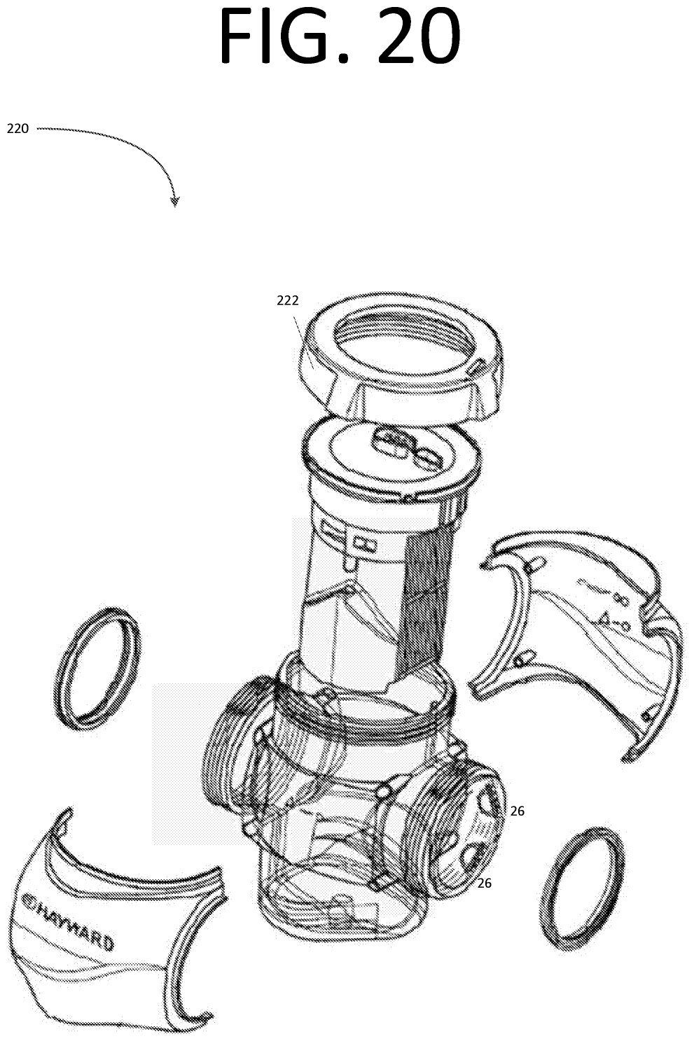

FIG. 20 is an exploded view of a cartridge chlorinator UV light fluid sanitization system 220 of the present disclosure. As shown in FIG. 20, a plurality of UV LEDs 26 are coupled to interior surfaces of the cartridge chlorinator 222. The UV LEDs 26 emit UV light at a wavelength of approximately 200 nm to 300 nm to sanitize and/or disinfect the fluid (e.g., water) in contact with the interior surfaces of the cartridge chlorinator 222. Alternatively, the plurality of UV LEDs 26 may be coupled to interior surfaces of a salt chlorinator.

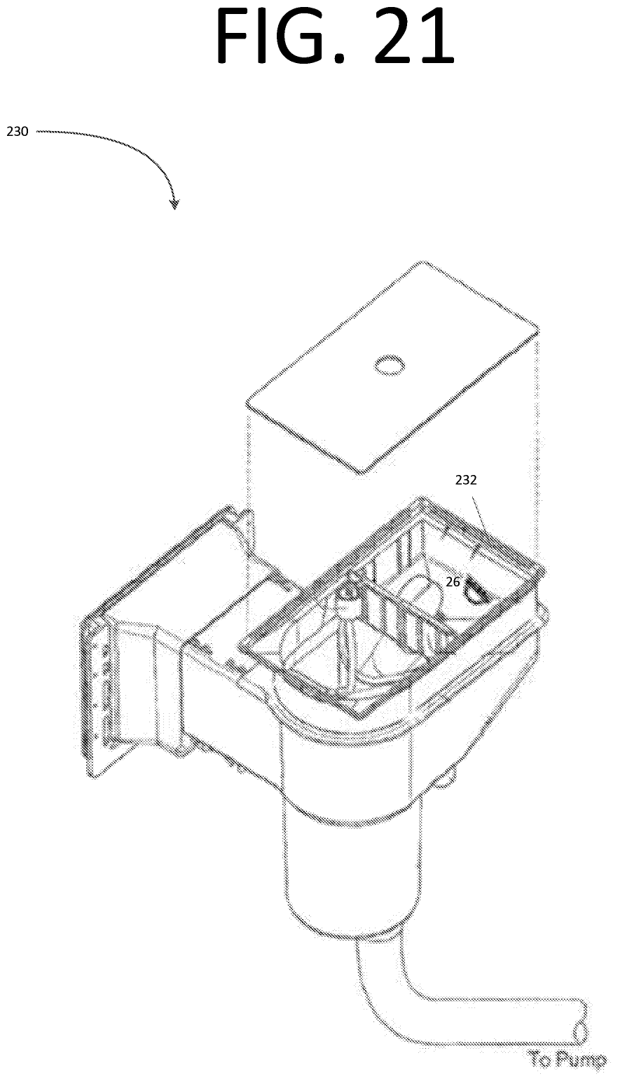

FIG. 21 is a perspective view of a tablet chlorinator UV light fluid sanitization system 230 of the present disclosure. As shown in FIG. 21, at least one UV LED 26 is coupled to an interior surface of the tablet chlorinator 232. The UV LEDs 26 emit UV light at a wavelength of approximately 200 nm to 300 nm to sanitize and/or disinfect the fluid (e.g., water) in contact with the interior surfaces of the tablet chlorinator 232.

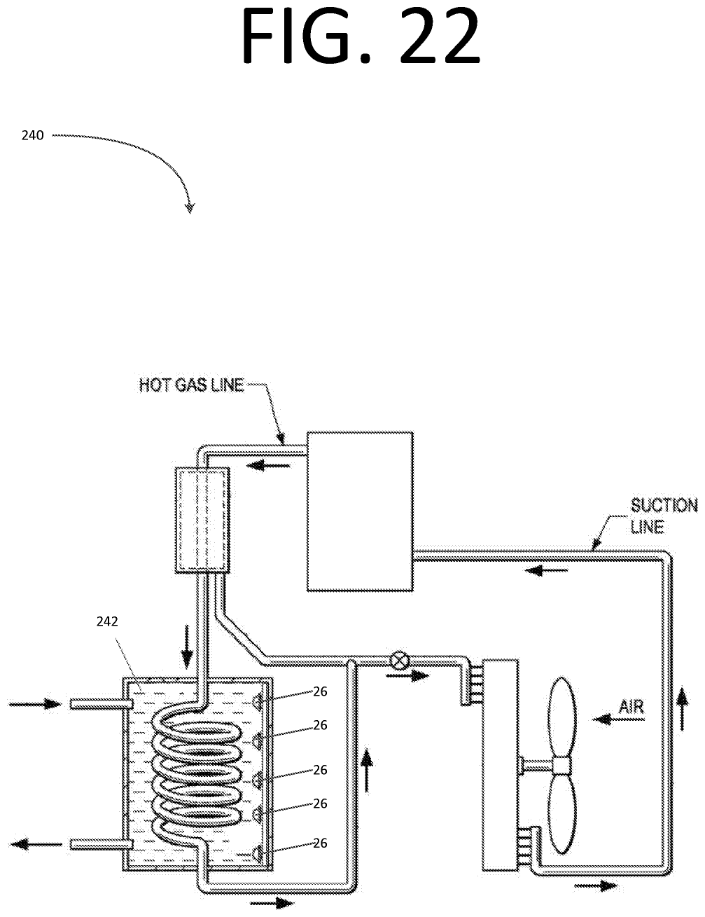

FIG. 22 is a side view of a pool heater UV light fluid sanitization system 240 of the present disclosure. As shown in FIG. 22, a plurality of UV LEDs 26 are coupled to interior surfaces of the pool heater 242. The UV LEDs 26 emit UV light at a wavelength of approximately 200 nm to 300 nm to sanitize and/or disinfect the fluid (e.g., water) in contact with the interior surfaces of the pool heater 242.

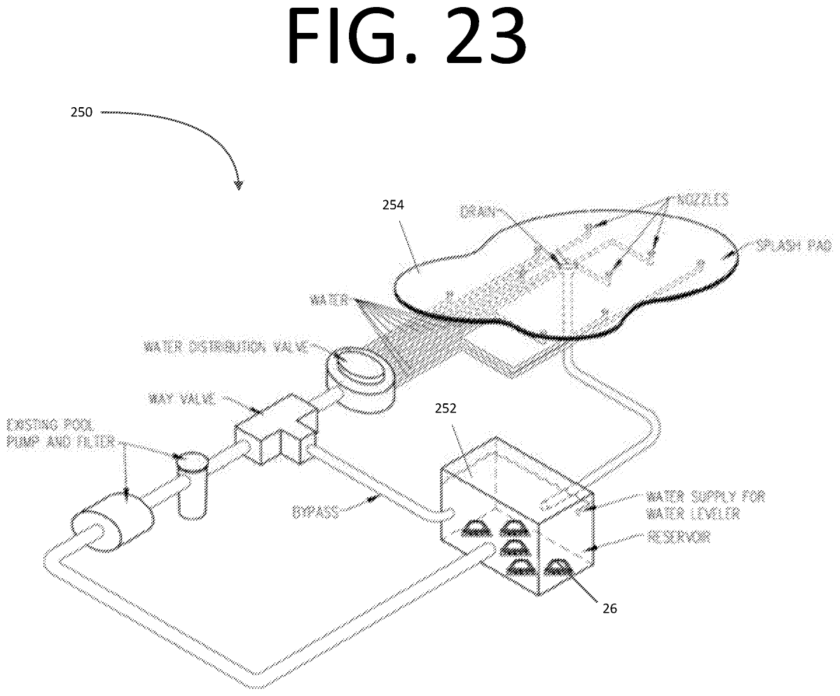

FIG. 23 is a perspective view of a splash pad UV light fluid sanitization system 250 of the present disclosure. As shown in FIG. 23, a plurality of UV LEDs 26 are coupled to interior surfaces of the water reservoir 252 of the splash pad 254. The UV LEDs 26 emit UV light at a wavelength of approximately 200 nm to 300 nm to sanitize and/or disinfect the fluid (e.g., water) in contact with the interior surfaces of the water reservoir 252 of the splash pad 254.

Having thus described the present disclosure in detail, it is to be understood that the foregoing description is not intended to limit the spirit or scope thereof.

What is claimed is:

1. A system for sanitizing and/or disinfecting fluid within a pool or a spa comprising:
a power supply;
at least one ultraviolet light-emitting diode coupled to a pool or spa component and in contact with the fluid within the pool or the spa; and
a controller in communication with the power supply and the at least one ultraviolet light-emitting diode, the controller driving the at least one ultraviolet light-emitting diode to emit ultraviolet light at a wavelength to sanitize and/or disinfect the fluid within the pool or the spa.

2. The system of claim 1, wherein the power supply comprises a watertight, 12-volt, direct current power supply.

3. The system of claim 1, wherein the at least one ultraviolet light-emitting diode emits ultraviolet light at a wavelength of 200 nm to 300 nm to sanitize and/or disinfect the fluid within the pool or the spa.

4. The system of claim 1, wherein the at least one ultraviolet light-emitting diode is one of a plurality of ultraviolet light-emitting diodes of an ultraviolet light-emitting diode bank, the plurality of ultraviolet light-emitting diodes being connected in series or in parallel.

5. The system of claim 1, wherein the system is coupled to a pool or a spa filtration system.

6. The system of claim 1, further comprising a venturi mounted with respect to the pool or the spa and in contact with the fluid within the pool or the spa, wherein the processor drives the venturi to introduce oxygen to the fluid within the pool or the spa and drives the at least one ultraviolet light-emitting diode to emit light at a wavelength of 185 nm to create ozone to sanitize and/or disinfect the fluid within the pool or the spa.

7. The system of claim 1, wherein the pool or spa component comprises one or more of a water feature, a tile, a deck jet, a spa jet, a fluid sanitization system, a ladder, a cover, a skimmer, a cleaner, a filter, a pump, a valve, a chlorinator, a heater, a splash pad, or a surface of a pool or spa.
